(19) United States
(12) Patent Application Publication
(10) Pub. No.: US 2013/0240458 A1
(43) Pub. Date: Sep. 19, 2013

(54) ELECTROLYSIS CELL FOR GENERATING OZONE FOR TREATING A LIQUID

(71) Applicants: Berthold Conradt, Wiesbaden (DE); Peter Weidner, Rotz (DE); Ron Kemmer, Wertheim (DE)

(72) Inventors: Berthold Conradt, Wiesbaden (DE); Peter Weidner, Rotz (DE); Ron Kemmer, Wertheim (DE)

(73) Assignee: BRITA GMBH, Taunusstein (DE)

(21) Appl. No.: 13/990,585

(22) PCT Filed: Dec. 2, 2011
(86) PCT No.: PCT/EP2011/071586

§ 371 Date: May 30, 2013

(30) Foreign Application Priority Data
Dec. 3, 2010 (DE) 10 2010 062 433.0

(51) Int. Cl. C02F 1/78; C25B 1/13

(52) U.S. Cl. CPC C02F 1/78; C25B 1/13
USPC 210/748.19; 204/242; 210/198.1; 210/96.1; 210/748.17

(57) ABSTRACT

An electrolysis cell for generating oxidizing agents, in particular ozone, for treating a liquid comprises a first electrode and a second electrode. The first and the second electrodes are spaced apart from one another by a distance (A). A particulate solid electrolyte is arranged between the first and the second electrodes and can have the liquid flowing through it. The solid electrolyte is arranged in a free space bounded by the first and the second electrodes.

### FIELD OF THE INVENTION

The present invention relates to an electrolysis cell for generating oxidants, in particular ozone, for treating a liquid, comprising a first electrode and a second electrode, wherein the first electrode and the second electrode are arranged at a distance to one another and wherein a particulate solid-state electrolyte is arranged between the first electrode and the second electrode, through which the liquid can flow.

The invention further concerns an apparatus for treating a liquid, comprising an inlet for introducing liquid into the apparatus, an outlet piece for discharging the treated liquid from the apparatus, a treatment region which can be supplied with water for treating the water.

In addition, the invention relates to a method of generating ozone for the treatment of a liquid.

### BACKGROUND OF THE INVENTION

Liquid dispensing or drinking water dispensing apparatuses such as for example coolers, chillers, water bars or vending machines, usually have long conduit systems which have inlets and outlet pieces via which the drinking water is supplied to the apparatuses and discharged therefrom. The outlet pieces in particular give rise to the risk of retrograde contamination of the drinking water by undesirable and frequently health-endangering germs such as bacteria, protists, fungi, parasites, viroids, viruses, algae or prions, which are present in the conduit systems of the liquid dispensing or drinking water dispensing apparatuses and can become settled there. Thus, for example, contact of the outlet piece with the hand of a user can be sufficient to introduce germs into the outlet piece, which germs spread within the apparatus in a direction opposite the main direction of flow of the drinking water. However, a risk is posed not only by retrograde contamination but also by the conduit system itself, in which health-endangering germs can likewise be present and spread.

To prevent this contamination, it is known to inactivate the germs with the aid of various measures. The term inactivation is to be understood as measures which act on the germs so that they can no longer multiply. The germs need not necessarily be killed. With the inactivation of the germs, the formation of biofilms is avoided. These measures include, for example, irradiation of the liquid with UV light or the addition to the liquid of a purifying agent. The irradiation of the liquid with UV light has the disadvantage that the germs are inactivated only in the radiation region of the UV lamp, so that only some of the germs are inactivated and the germs which have not been inactivated can spread further in other places in the apparatus. The use of a purifying agent which can be transported through the entire apparatus has the disadvantage that it is generally not drinkable and therefore has to be collected and completely removed from the apparatus before the apparatus can be used again to dispense drinking water. This is disadvantageous in particular because the apparatus cannot fulfil its intended purpose for a certain time.

A further measure for inactivating the germs is the generating of oxidants which can be introduced into the liquid or the drinking water. Oxidants are, in particular, ozone, chlorine, chlorine dioxide, hydrogen peroxide and free hydroxyl radicals (OH radicals). The generating of oxidants has the advantage that their concentration in the liquid or in the drinking water can be controlled in such a way that the germs are reliably inactivated and the user is not exposed to any danger to health. Furthermore, the oxidants can be conveyed together with the liquid through the entire apparatus, so that all conduit sections are treated with the oxidant and the germs are inactivated everywhere.

Ozone is usually produced by means of a corona discharge process. This process produces gaseous ozone which is subsequently introduced into the liquid to be treated. An air/water mixing unit is necessary for this purpose. A gas separator is required since residual gases which can be toxic to the user have to be destroyed.

These disadvantages can be circumvented through use of an electrolysis cell for generating oxidants and in particular ozone for the treatment of a liquid. The “Fischer cell” known from the prior art, which is suitable for this purpose, comprises sheet-like electrodes which are pressed against a membrane located between the electrodes. The electrodes used consist of lead oxide and, especially in the case of discontinuous operation of the apparatus, have the disadvantage that they release lead constituents into the liquid to be treated, which is unacceptable in terms of the health of the user.

DE 103 16 759 discloses electrodes which have a diamond coating. However, the electrolysis cells disclosed therein serve the treatment of gases, so that application to the present case is not possible. In particular, in the treatment of liquids the problem occurs that the maximum volume stream which can be passed through the electrolysis cell represents a limiting factor due to the incompressibility of liquids.

DE 10 2004 015 680 A1 discloses an electrolysis cell which is suitable for treating liquids, in which a solid-state electrolyte is arranged between the electrodes. To guarantee the stability of the electrolysis cell, the solid-state electrolyte has to be provided in a relatively complicated shape, which gives rise to a high volume requirement. The polymeric solid-state electrolyte membranes used have to be kept continually moist in order not to lose their ability to function. This is a disadvantage for storage, simple transport and replacement of a used electrolysis cell.

Electrodes in planar form without openings, wherein the liquid flows between the first electrode and second electrode are simpler to produce than planar electrodes through which channels run in order to convey the liquid to the membrane, as are described in DE 100 25 167 A1. This also applies to the mesh electrodes described in DE 10 2004 015680 A1.

U.S. Pat. No. 6,254,762 discloses an electrolysis cell with two chambers for the production of hydrogen peroxide. One can make this apparatus give off ozone by selecting a suitable catalyst. A main body of the electrolysis cell is divided into an anode chamber and a cathode chamber by means of an ion-exchange membrane. The ion-exchange membrane has a gas diffusion anode which is in close contact with the membrane on a side facing the anode chamber. In the cathode chamber, a gas diffusion cathode is positioned spaced from the ion-exchange membrane, so that the cathode is in contact with the upper side and the underside of the main body of the electrolysis cell in order to divide the cathode chamber into a solution chamber on the side facing the anode chamber and a gas chamber on the opposite side. The solution chamber is completely filled with ion-exchange resin particles. The upper side and the underside of the solution chamber have a feed opening for ultrapure water and a discharge opening for an aqueous hydrogen peroxide solution, respectively. The feed opening and the discharge opening each have a stopper to prevent the ion-exchange resin particles from flowing out. The anode chamber has a hydrogen gas feed opening and an excess gas discharge opening which are formed in lower and upper parts, respectively, of the anode chamber. Furthermore, the cathode chamber has an oxygen gas feed opening and an excess gas discharge opening which are formed in the lower and upper parts, respectively, of the cathode chamber. When a voltage is applied to the two electrodes while hydrogen gas is fed into the anode chamber, an oxygen-containing gas into the cathode chamber and ultrapure water into the solution chamber, an electric current having a relatively high current density flows through the cathode and the anode, even though the electrical conductivity of the ultrapure water is virtually zero. This is because the two electrodes are electrically connected to one another via the ion-exchange membrane and the ion-exchange resin particles, which both have electrical conductivity.

However, the known electrolysis cell functions only with ultrapure water. If mains water were to be used, deposits would fairly quickly be formed in the solution chamber.

### SUMMARY OF THE INVENTION

It is therefore an object of the present invention to provide an electrolysis cell which is also suitable for the treatment of liquids other than high-purity water.

The object is achieved by an electrolysis cell of the type mentioned at the outset in which the solid-state electrolyte is arranged in a free space delimited by the first electrode and the second electrode.

In this context, a particulate solid-state electrolyte is to be understood as an electrolyte which comprises a plurality of solid bodies having small dimensions. In particular, the predominant particle size of the solid-state electrode should be less than 1 mm. The particulate solid-state electrolyte may be present in the form of a granular material, a suspension or a powder. Furthermore, the particulate solid-state electrolytes can also be joined to form a larger unit, for example using a binder. Herein, particles having an average diameter of 1 mm and more can be created.

For the generation of a sufficient amount of ozone, and in particular a high ozone yield compared to other oxidants such as chlorine, a particular current density is necessary. The ozone yield is the proportion of ozone in the total amount of oxidants produced. The ozone yield also increases with increasing current density. However, the conductivity of the liquid decreases with increasing purity. As a consequence, a higher voltage is required for producing the required current density. Compared to other oxidants, ozone has the advantage that it decomposes to odourless oxygen and has a higher effectiveness in the inactivation of germs and any biofilms present. Furthermore, the formation of disinfection by-products (DBP) such as chloroform is reduced.

By means of the particulate solid-state electrolyte through which liquid can flow, high current densities can be produced without the two electrodes being short-circuited. The solid-state electrolyte promotes the conduction of ions through the liquid from the first electrode to the second electrode, so that smaller voltages are sufficient to produce the necessary current density compared to known electrolysis cells which do not have a particulate solid-state electrolyte. The electrolysis cell can therefore be operated more cheaply. Since lower voltages can be employed in this embodiment, this contributes to the safety of the electrolysis cell. Furthermore, the electronics can be made simpler.

In addition, particulate solid-state electrolytes guarantee good flow through the space between the electrodes, so that a sufficiently high volume flow of the oxidant can be obtained without the flow resistance or the pressure drop in the electrolysis cell becoming too large.

Because the free space is empty but for the solid-state electrolyte, i.e. no further objects are arranged in the free space between the electrodes, the electrodes can be arranged at a very small distance to one another and a sufficiently high volume flow can nevertheless be passed through. The first surface area and the second surface area of the electrodes can be reduced with decreasing distance. Furthermore, the space requirements of the electrolysis cell decrease with decreasing distance between the two electrodes, so that the cell can also be arranged in regions having little room for installation, for example directly in the inlet or outlet of an apparatus for treatment of a liquid.

Because the free space is not sub-divided into further spaces, the polarity of the electrolysis cell can be reversed during operation, i.e. each of the first and second electrodes can alternately act as anode or cathode. Deposits on the electrodes are largely avoided in this way. This is not possible in an electrolysis cell having separate feed openings for different gases without a relatively complex arrangement of automatically regulated valves.

The electrolysis cell thus has a housing having at least one inlet for the liquid to be treated and at least one outlet for the treated liquid, with all inlets and outlets being located between faces defined by the first electrode or by the second electrode. The electrolysis cell can therefore be relatively compact, since no chamber has to be arranged on the side of each electrode facing away from the other electrode. In this sense, the electrolysis cell can be symmetrical about an imaginary plane between the electrodes, so that changing the polarity during operation is possible without problems.

In an embodiment, the particulate solid-state electrolyte is present in one of powder form, granulated form, sintered form and as extruded form. The powder should, by definition, comprise particles having a very small particle size, in particular below 0.5 mm. This increases the specific surface area, so that the contact area with the liquid which is to be enriched with ozone is increased. The enrichment with ozone is therefore accomplished more effectively.

When sintering, one starts with a particulate solid-state electrolyte, wherein the particle size may also be selected so as to correspond to that of a powder. The particulate solid-state electrolyte is converted into the sintered form by heat treatment and alternatively also using a binder. As a result, the particulate solid-state electrolyte takes on a solid form so that it is easier to handle. The particulate solid-state electrolyte can thus be produced in disk or plate form.

Furthermore, the solid-state electrolyte may be present in extruded form. Here too, the solid-state electrolyte has a solid shape, of which the cross-section corresponds to that of the extruder, after processing. This can also be tubular. Here too, the handleability is improved. The extruded form can be comminuted by means of a further process step, for example by cutting the extruded form.

In an embodiment, the free space is completely filled with solid state electrolyte.

An effect is that the electrical resistance of the electrolysis cell is relatively constant from the beginning, which simplifies operation of the electrolysis cell. Otherwise, the electrical resistance would decrease after first contact with the liquid due to swelling of the particles since the swelling of the particles would bring about better coverage and firmer contact between the particles and the electrode surfaces.

In an embodiment, the distance between the two electrodes using the particulate solid-state electrolyte is from 1.5 to 2.5 mm. The first surface area and the second surface area of the electrodes can be reduced with decreasing spacing. The space requirement for the electrolysis cell decreases with decreasing spacing of the two electrodes, so that it can also be arranged in regions in which there is little room for installation. The current density between two electrodes increases with the conductivity of the liquid present between the electrodes and the applied voltage, but decreases with increasing distance between the two electrodes. If the distance between the electrodes is reduced, the current density increases at the same voltage, as a result of which the current, which rises with the current density and the electrode area, increases. To return to the original current, the electrode area can be reduced. The electrolysis cell can thus be made even more compact, the smaller the distance between the two electrodes. The production of oxidants likewise increases with increasing current.

It has been found that at an average current density of more than 0.1 A/cm² applied to the electrolysis cell, the amount of ozone produced is sufficient effectively to disinfect liquids having a conductivity of 10 μS/cm or more. Significantly higher current densities can be achieved locally in the cell itself. This ensures that a major part of the drinking water can be treated by means of the electrolysis cell of the invention without additional measures such as softening or partial or total demineralisation.

Although the electrolysis cells of the invention serve mainly for producing ozone, the formation of other oxidants in the form of chlorine, chlorine dioxide, hydrogen peroxide and free hydroxyl radicals (OH radicals) cannot be avoided. Since these also kill or at least inactivate germs, the formation of these other oxidants is not disadvantageous in this respect. However, they lead to undesirable gustatory changes in the liquid and can produce an unpleasant odour. As mentioned above, the formation of these and other oxidants and their disinfection by-products cannot be avoided, but the ozone yield relative to the yield of the other oxidants can be increased by means of an increased current density.

The particulate solid-state electrolyte may be an ion exchanger, in particular a proton-conducting ion exchanger, more particularly a zeolite or a polymer, even more particularly a tetrafluoroethylene polymer. A sulfonated tetrafluoroethylene polymer such as Nafion has been found to be particularly suitable. It is very particularly effective when the ion exchanger is a zeolite which has been made acidic or a polymer. A proton-conducting ion exchanger is a cation exchanger which makes protons available. Zeolites which have been made acidic make protons available, so that a type of “proton chain” is formed between the two electrodes and contributes to increasing the conductivity between the electrodes. A proton-conducting ion exchanger increases the flow of current and therefore also the current density at the same voltage compared to electrolysis cells without a proton-conducting solid-state electrolyte. A particular property of the sulfonated tetrafluoroethylene polymer is that it does not have to be kept moist in order to ensure its ability to function.

Furthermore, zeolites which have been made acidic and polymers have the property that they are more resistant to oxidation compared to other cation exchangers. Apart from cation exchangers, the use of anion exchangers is also conceivable, but the ozone yield produced therewith is lower compared to cation exchangers since the conductivity can best be increased by means of protons.

The polymer which has been made acidic can be a sulfonated tetrafluoroethylene polymer such as Nafion. The polymer can be extruded and subsequently converted into particles.

The electrolysis cell may be developed further by means of a retention device for retaining the particulate solid-state electrolyte in the electrolysis cell. This ensures that the particulate solid-state electrolyte is not flushed out of the free space between the electrodes. This is particularly important when the particulate solid-state electrolyte is present as a powder or particulate material with a small particle size. The retention device can, for example, be in the form of a screen having a mesh size matched to the particle size of the particulate solid-state electrolyte or in the form of a non-woven material. Solid-state electrolyte crystals held together by a binder may also form the retention device. The flow resistance or the pressure drop caused by the retention device is thus kept small, so that a large volume flow can be passed through the electrolysis cell.

In an embodiment, the first electrode and the second electrode are provided with a support core and a diamond coating. Any suitable material and in particular metal can be used as support core. The diamond coating is very stable, so that the electrodes have a very long life because the diamond coating protects the electrodes against corrosion by the oxidants such as ozone to a high degree. Furthermore, it is prevented that constituents of the electrodes that may be harmful to the user are released into the liquid, as may be the case for lead oxide electrodes, especially in discontinuous operation of the electrolysis cell. Diamond as such is a very good insulator, so that no current density could be introduced into the liquid to be treated. The diamond coating therefore does not consist of pure diamond but instead is doped, for example with boron, so that the diamond coating becomes electrically conductive. The diamond coating has a thickness of from about 5 to 10 μm and can be applied by means of a vapour deposition process to the support core.

When both the first electrode and the second electrode are provided with a diamond coating, a reversal of polarity is made possible, which should occur at regular intervals. The polarity reversal means that it is not always only one electrode that acts as an anode and the other acts as a cathode. A deposit, in particular as a result of lime deposition, can form at the cathode, which is significantly reduced and becomes more uniformly distributed over the two electrodes so that the life of the electrolysis cell is increased, due to the polarity reversal. Otherwise, the electrolysis cell would cease to function after only a relatively short time if a lime-containing liquid, for example mains water, were supplied to it.

Not only the deposit on the electrodes can lead to problems, but also deposition in the solid-state electrolyte arranged between the first electrode and the second electrode can adversely affect the operation. In this case, regular flushing with liquid containing substances which break down the deposits can lead to an increase in lifetime. Thus, for example, lime deposits can be removed by means of liquid admixed with CO₂. Such liquid is, for example, available in many drinking water dispensing apparatuses. Thus, no additional harmful chemicals are used.

A further possible way of avoiding deposition is to install a filter unit upstream of the electrolysis cell so as to remove substances which produce deposits from the drinking water. This can, for example, be achieved by means of an ion exchanger to demineralise the liquid to be treated. In an embodiment, the filter unit arranged upstream of the electrolysis cell comprises an anion exchanger in sulphate form. In this way, bromide and iodide can be removed from the liquid. As a result, no bromate or iodate can be formed in the electrolysis.

In an embodiment of the invention in which the first electrode has a first surface and the second electrode has a second surface, the first surface and the second surface are arranged in plan-parallel. Uniform distribution of the current density between the electrodes can be brought about in this way. It is thus ensured that the current density required for inactivation of the germs is established everywhere between the electrodes.

Fundamentally, the geometric shape of the electrodes can be chosen freely. The geometric shape of the electrodes has an influence on the current densities. Thus, it is possible to dip rod-shaped electrodes into an ion exchanger bed. It is also possible to combine electrodes having different shapes in an electrolysis cell. It is in this way possible to produce a different current density by means of which the ozone yield can be controlled. It has been found that the ozone yield compared to the other oxidants increases with increasing current density.

The support core may consist of ceramic material or more generally comprise the ceramic material. The support core may thus consist exclusively of ceramic material or also have other components in addition to the ceramic material and may, in particular, be modified with organic components. The ceramic material is particularly corrosion-resistant and therefore increases the life of the electrolysis cell. Furthermore, no substances which are hazardous to health are released into the liquid flowing around the electrodes.

Furthermore, it is possible for the first surface and the second surface to be provided with one or more projections. Point discharges occur at the projections, so that high current densities are produced at these points without the voltage having to be increased. The production of oxidants is thus made more efficient. Furthermore, in combination with the support material composed of a ceramic material, the projections can be made very uniform since the ceramics can be shaped very precisely. The high current density at points can be set very exactly both in terms of location and in terms of extent.

A further aspect of the present invention concerns an apparatus for treating a liquid, comprising an inlet for introducing liquid into the apparatus, an outlet piece for discharging the treated liquid from the apparatus, a treatment region which can be supplied with water for treating the water and an electrolysis cell according to the invention for generating oxidants, and in particular ozone, for the treatment of the liquid.

Due to the free space's being empty in this embodiment, respectively there being no objects arranged in the free space between the electrodes, the electrodes can be arranged at a very small distance to one another and a sufficiently high volume flow can nevertheless be passed between them. The first surface area and the second surface area of the electrodes can be reduced with decreasing spacing. Furthermore, the space requirement for the electrolysis cell decreases with decreasing spacing of the two electrodes, so that they can be arranged even in regions with little room for installation, for example directly in the inlet or outlet of the apparatus.

In the apparatus according to the invention, a particulate solid-state electrolyte is arranged in the free space. The liquid to be enriched with the oxidant can readily flow through the particulate solid-state electrolyte. The particulate solid-state electrolyte enables high current densities to be produced without the two electrodes being short-circuited. The particulate solid-state electrolyte conducts ions through the liquid from the first electrode to the second electrode, so that lower voltages are sufficient for producing the necessary current density compared to known electrolysis cells that are not provided with a particulate solid-state electrolyte. The electrolysis cell is therefore cheaper to operate.

In an embodiment, the apparatus is configured to reverse the polarity of the electrolysis cell, so that the first electrode and the second electrode alternately act as cathode and as anode. This effectively counters formation of a coating, so that the electrolysis cell continues to function for an acceptable time even in the generating of ozone from mains water.

In a variant, the polarity reversal occurs at regular intervals.

In an embodiment, the apparatus is arranged to apply a voltage above a threshold value to the electrodes. In a variant, the threshold value is at least 8 V/mm, based on the distance between the first electrode and the second electrode, in particular at least 9 V/mm, more particularly 10 V/mm. These values are particularly suitable for producing ozone from mains water when the solid-state electrolyte comprises a strongly acidic ion exchanger, for example a sulfonated fluoropolymer.

Below the threshold value, the current flow can drop precipitously after only a relatively short time, so that the production of ozone is greatly reduced. A possible explanation is that the solid-state electrolyte becomes saturated with cations, in particular hardness-forming cations, so that its electrical conductivity decreases greatly. Increasing the voltage to above a suitable threshold value brings about detachment of the bound cations.

In an embodiment, the apparatus is therefore arranged to recognise a decrease in a current through the electrolysis cell and, in response to the recognition, to increase the voltage at least temporarily to a value above a particular threshold value.

In an embodiment, the apparatus comprises a measurement device for determining at least one parameter from the group comprising conductivity, ozone content and oxidation-reduction potential of the liquid. With the aid of the determination of the conductivity, the ozone content or the oxidation-reduction potential, the cell may be activated (too little oxidant or ozone in the liquid) or deactivated (too much oxidant or ozone in the liquid). Further determinable events for activation and deactivation of the cell may be a time interval or a point in time or the introduction of untreated liquid into the apparatus. The apparatus may be operated in such a way that a concentration of the oxidant which is necessary for reliable inactivation of the germs is produced or maintained. This prevents production of an excessively high concentration of the oxidant, which causes unnecessary costs, has an adverse effect on the taste of the liquid or results in limit values for liquids (in particular drinking water) being exceeded. Furthermore, the formation of disinfection by-products is reduced.

In an embodiment, the apparatus comprises a measurement device for determining the conductivity of the liquid, wherein the apparatus is configured to set a cell voltage in dependence on the conductivity.

Sufficient production of oxidants can be ensured in this way. The apparatus is also better suited to treating mains water, of which the conductivity can fluctuate within particular limits, in this embodiment.

In an embodiment, the cell resistance can be determined by means of the measurement device, wherein the measurement device comprises a power supply for controlling the voltage in dependence on the measured cell resistance. In this embodiment, the current density in the electrolysis cell can be altered based on the measured conductivity, the ozone content or the oxidation-reduction potential of the liquid. This is effected by the current-voltage-regulated power supply by means of which the current can be kept constant and the voltage can be changed in dependence on the measured conductivity of the liquid. Oxidant generation and the proportion of ozone in the oxidants may be adapted to the conductivity of the liquid with the power supply. A separate measurement device is not necessary, so that the number of components and thus the complexity of the apparatus and also the space required for installation can be reduced.

In an embodiment of the invention in which the apparatus further comprises a tank for storing the liquid and conducting means for conducting the liquid into the apparatus, the electrolysis cell is arranged in the tank, in the inlet, in the conduct means or in the outlet piece. Since the electrolysis cell of the invention requires little space for installation, it can be arranged in all regions of the apparatus. The place at which the electrolysis cell is arranged coincides with the introduction of the oxidant into the liquid, so that the electrolysis cell can be arranged in places in the apparatus which are critical for germ growth, for example in the outlet piece or in the feed line for untreated liquid.

In an embodiment, the outlet piece comprises a closable opening for selective discharge of the liquid, a supply element for supplying the liquid to the outlet piece and a discharge element for discharging the liquid from the outlet piece and leading it into the tank. The outlet piece may also be bathed in the treated liquid when the liquid is not to be discharged via the outlet piece. The disinfecting effect of the liquid admixed with the oxidant is put to use to disinfect the outlet piece. This is effective in particular because the outlet piece represents a critical place for retrograde contamination since it forms the interface with the surroundings in which a large number of germs are present.

The liquid discharged from the outlet piece may be recirculated to the tank. Furthermore, it is also possible to operate the apparatus in such a way that the liquid is circulated. In this embodiment, a particular volume of the liquid is circulated within the apparatus, repeatedly enriched with oxidant, and in particular ozone, and brought to a particular concentration.

Since, firstly, a smaller amount or no fresh liquid at all need be supplied, this embodiment has the effect that the amount of consumed liquid can be reduced and appliances can therefore also be operated without discharge. On the other hand, the quantity of oxidants to be generated in the cell is reduced, which in turn leads to a reduction in the costs for the supply electronics. Furthermore, the cell can be switched on and off in dependence on the determined value of the conductivity, the oxidation-reduction potential or the ozone content, whilst the liquid is circulated, so that a certain concentration is never undercut or exceeded.

Furthermore, one may, by adapting the current density, choose the oxidant and ozone concentration produced in the electrolysis cell, either so that a very large amount of oxidant, and in particular ozone, is produced and the liquid is not circulated or circulated to only a small extent, or one may generate only little ozone in the electrolysis cell and circulate the liquid a number of times, so that the ozone concentration in the apparatus is gradually increased and brought to the desired value. The decomposition time of ozone has to be taken into account here. As mentioned above, the ozone yield can also be altered in a targeted manner by means of the current density, wherein an increasing current density leads to an increasing ozone yield.

In an embodiment, a transport device is provided for transporting the liquid within the apparatus. However, depending on the configuration of the apparatus, the apparatus can also be operated without a transport device, in which case the pressure in the feed line or the hydrostatic pressure in the tank bring about transport of the treated liquid.

Furthermore, the enrichment of the liquid present in the apparatus with oxidants, in particular with ozone, is made easier with the transport device, since the circulation rate can be altered independently of the mains pressure. As mentioned above, ozone decomposes spontaneously after some time. For an increase in the ozone concentration nevertheless to be achieved, the circulation rate has to be adapted accordingly to the decomposition time, which can be achieved without problems by means of the transport device.

Apart from transport in a cycle, the presence of a transport device also offers further possibilities: the liquid can be conducted within the apparatus independently of structural circumstances and the prevailing mains pressure. It is also possible to carry out transport at regular time intervals and/or in dependence on the amount of liquid drawn by the user, change the transport rate and thus the pressure within the apparatus.

An embodiment of the apparatus is distinguished by a unit for reducing the concentration of the oxidant. This unit may comprise a UV lamp, activated carbon, glass fibres or another catalytically active element and may, for example, be arranged in the region of the outlet piece. This embodiment makes it possible to produce a concentration of the oxidant within the apparatus which is higher than that which is acceptable and permissible for use of the liquid, in particular as drinking water. Furthermore, a high concentration of oxidant can cause an undesirable odour and adversely affect the taste of the drinking water.

The unit for reducing the concentration of the oxidant may be arranged outside the recirculation circuit. However, it may also be arranged within the recirculation circuit. In this case, the drawing of liquid by the user is, in an embodiment, not possible during the circulation process, and the unit for reducing the concentration of the oxidant is switched off.

It is thus possible to produce a concentration of the oxidant within the apparatus which is higher than that dispensed via the outlet piece, so that a very reliable and lasting inactivation of the germs can be effected within the apparatus.

In an embodiment, the apparatus comprises a bypass having a first section and a second section, wherein the electrolysis cell is arranged in one of the sections. As the term bypass indicates, the first section and the second section are connected in parallel in flow sense. The bypass enables simple replacement of the electrolysis cell, and the enrichment of the liquid with ozone can be set in a simple way by selection of the volume streams through the first section and the second section. Furthermore, a treatment unit for conditioning the liquid, for example a filter unit, can be arranged in the bypass upstream of the electrolysis cell. In addition, the content of undesirable substances such as bromide and iodide can be reduced by passing a proportion of the liquid through the section other than the section containing the electrolysis cell and subsequent blending of the liquid which has been treated by means of the electrolysis cell with the liquid passed through the other section. In general, the ozone content in the blended liquid will also be sufficient for disinfection purposes.

In the above-described possibilities for optimising the germ inactivation process for the liquid and the liquid-conducting components, it should be noted that the oxidant or ozone concentration does not necessarily have to be so high that virtually all germs are killed. Rather, in many cases germ removal can be considered to be reliably effected when the oxidant and ozone concentration is maintained at a comparatively low value sufficient to inactivate the germs at regular intervals by means of appropriate activation of the electrolysis cell. A certain number of germs can be tolerated, but an increase must not occur. Thus, the formation of biofilms may also be countered with a low oxidant and ozone concentration and thus low energy consumption.

A further aspect of the present invention concerns a method of generating ozone for the treatment of a liquid, comprising the following steps: determining the conductivity, the oxidation-reduction potential or the ozone concentration of a liquid present in an apparatus according to the invention by means of a measurement device, activating a generator for producing an oxidant, in particular ozone, in dependence on the determined conductivity, oxidation-reduction potential, ozone concentration or a determinable event by means of the measurement device and treating the liquid and the liquid-conducting parts of the apparatus with the oxidant, in particular ozone.

Liquid-conducting parts are to be understood as all parts of the apparatus which come into contact with the liquid.

The generator for generating oxidants, and in particular ozone, is an electrolysis cell according to one of the embodiments presented above.

The advantages discussed for the apparatus of the invention and the electrolysis cell of the invention thus apply equally to the method of the invention. The indicated sequence of the method steps is not to be understood as a stipulation thereof. Rather, a different sequence is also conceivable.

In an embodiment, the determinable event is the oxidation-reduction potential or the ozone concentration measured by means of the measurement device exceeding or undercutting a certain threshold value. The oxidation-reduction potential changes with the concentration of the oxidant produced, so that, for example, the production of the oxidant, and in particular of ozone, can be started when the concentration thereof goes below a predetermined threshold value and can be stopped when a pre-determined threshold value is exceeded. The concentration of the oxidant, in particular of ozone, in the liquid may thus be kept between limits that may be chosen, so that the apparatus is operated efficiently and cheaply and permissible maximum concentrations are not exceeded.

The determinable event may be the supply of untreated liquid into the apparatus. The untreated liquid usually has a large number of germs, so that the supply of untreated liquid into the apparatus represents an event which makes an increase in the concentration of the oxidant, in particular of ozone, necessary. Reliable inactivation of the germs can thus be brought about even without measurement of the oxidation-reduction potential or of the ozone concentration.

The determinable event may be a time interval or a point in time. It is thus possible to activate the electrolysis cell at regular intervals for a particular period of time. For example, the electrolysis cell can be activated for a particular duration every two hours. As an alternative, it is possible to select a particular point in time at which the apparatus is not normally used, for example during the night, for activating the electrolysis cell.

In an embodiment, the process comprises applying a voltage above a threshold value to the electrodes. In a variant, the threshold value is at least 8 V/mm, based on the distance between the first electrode and the second electrode, in particular at least 9 V/mm, more particularly 10 V/mm. These values are particularly suitable for producing ozone from mains water when the solid-state electrolyte comprises a strongly acidic ion exchanger, for example a sulfonated fluoropolymer.

Below the threshold value, the current flow can drop precipitously after only a relatively short time, so that ozone production is greatly reduced. A possible explanation is that the solid-state electrolyte becomes saturated with cations, in particular hardness-forming cations, so that its electrical conductivity decreases strongly. Increasing the voltage to above a suitable threshold value causes detachment of the bound cations.

In an embodiment, the process comprises recognising a drop in current through the electrolysis cell and at least temporarily increasing the voltage across the electrodes to a value above a particular threshold value in response to the recognition.

In an embodiment of the method, the polarity of the electrolysis cell is reversed so that the first electrode and the second electrode alternately act as cathode and anode.

This increases the suitability of the method for generating ozone from liquids other than ultrapure water, for example mains water. The formation of deposits at the electrodes is countered.

The polarity reversal may in particular, occur at regular intervals. The production of ozone remains relatively constant as a result.

### BRIEF DESCRIPTION OF THE DRAWINGS

The invention is explained in detail below with reference to the accompanying drawings. In the drawings:

FIG. 1 schematically shows an electrolysis cell according to the invention in accordance with a first embodiment,

FIG. 2 schematically shows an electrolysis cell according to the invention in accordance with a second embodiment,

FIG. 3 schematically shows an electrolysis cell according to the invention in accordance with a third embodiment,

FIG. 4 schematically shows an apparatus according to the invention and

FIG. 5 schematically shows a bypass according to the invention.

### DETAILED DESCRIPTION OF THE INVENTION

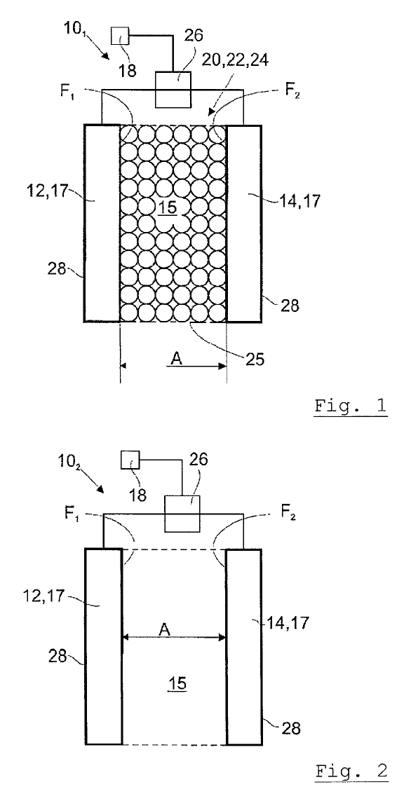

The electrolysis cell 10₁ depicted in FIG. 1 comprises a first electrode 12 having a first surface F₁ and a second electrode 14 having a second surface F₂, which face one another and are arranged at a distance A to one another. The electrodes 12,14 each have a support core 17 to which a diamond coating 28 has been applied. To be able to make the diamond coating 28 electrically conductive, it is doped. Furthermore, the electrolysis cell 10 comprises a measurement device 26 to determine the cell resistance and to activate the electrolysis cell 10 in dependence on a determinable event. The measurement device 26 is connected to a power supply 18 for controlling the voltage as a function of the measured cell resistance.

The two electrodes 12,14 form a free space 15 through which liquid, for example water, can flow, and which is filled with a particulate solid-state electrolyte 20, which may be an ion exchanger 22 or a zeolite 24 that has been made acidic or a polymer 24. As polymer 24, a sulfonated tetrafluoroethylene polymer, for example that which can be obtained under the trade name Nafion, has been found to be particularly suitable. It can, for example, be extruded and subsequently comminuted to the desired particle size. The average particle size diameter of the solid-state electrolyte 20 is selected so that the liquid can flow with a sufficiently large volumetric flow rate through the space between the two electrodes 12, 14. The particle size diameter may be in the range from 10 μm to 0.5 mm. In order to prevent the particulate solid-state electrolyte from being flushed out of the free space by the liquid flowing through, a retention device 25 is provided. This may, for example, be configured as a screen having an appropriate mesh size or as a layer of non-woven material. It is important here that the pressure drop produced when liquid flows through the retention device 25, respectively the flow resistance be kept small.

To produce an oxidant, a voltage is applied to the electrodes 12,14. A current density is established in the water which is present between the first electrode and the second electrode 12, 14 so as to ensure that, to present understanding, the following reactions can proceed at the anode:

6H₂O→6H⁺+6OH⁻ (1)

6OH⁻→6OH⁺+6e⁻ (2)

6OH*→6H⁺+2O₃+6e⁻ (3),

where OH* denotes OH radicals.

Accordingly, ozone is produced as oxidant, and the water in the electrolysis cell 10₁ is enriched therewith. On the first pass through the electrolysis cell 10₁, the oxidants, and in particular the ozone, subsequently mix with the remaining water which has not flowed through the electrolysis cell 10₁. If the water has already been enriched with oxidant, in particular with ozone, it is enriched with further oxidant and preferably with ozone. The volume flow through the electrolysis cell 10₁ and the concentration of the ozone produced are selected so that the ozone concentration in the total liquid present in the apparatus 30 is sufficient reliably to deactivate germs present in the liquid and on liquid-conducting parts without health-endangering limits being exceeded and/or the taste of the water being undesirably changed or an unpleasant door being released. A volume flow of about 30 l·h⁻¹ through the electrolysis cell has been found to be suitable. The average ozone concentration in the electrolysis cell should not exceed 50 μg·l⁻¹ since otherwise undesirable by-products, for example bromates, are produced to an increased extent. However, a significantly higher ozone concentration can also be generated locally in the electrolysis cell, which is appropriately diluted to the maximum desired ozone concentration in the tank. The by-products formed during production of oxidant and ozone are greatly dependent on the composition of the water to be treated, which can vary appreciably depending on the geological environment from which the water is taken. At an ozone concentration of 50 μg·l¹ or less, the formation of by-products remains within acceptable limits for the water which is commonly supplied from tap water mains. At the same time, the spread of germs in the liquid is prevented.

A second embodiment of an electrolysis cell 10₂ is shown in FIG. 2. In this case, the free space 15 is empty. Otherwise, the electrolysis cell 10₂ corresponds to that shown in FIG. 1.

An electrolysis cell 10₃ in accordance with a third exemplary embodiment is shown in FIG. 3. A ceramic material 29 is provided as support core 17. The first surface and the second surface F₁, F₂ are provided with one or, as shown, several projections 27 at which high current densities can be.

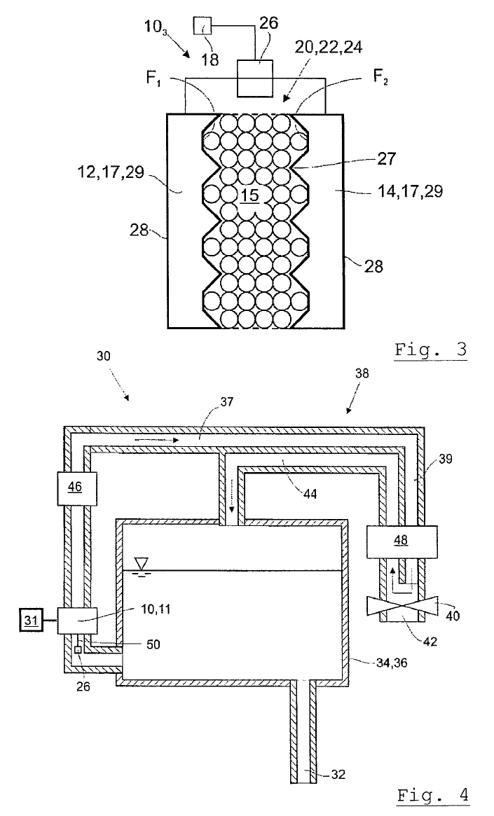

In FIG. 4, an apparatus 30 according to the invention for treating a liquid is shown, which comprises a generator 11 for producing ozone, which generator is, in the example shown, configured as an electrolysis cell 10 in accordance with one of the examples shown in FIGS. 1-3. A control device 31 controls the operation of the electrolysis cell 10. The apparatus 30 further comprises an inlet 32 by means of which an untreated liquid, in particular water, can be supplied to the apparatus 30. In the example shown, the inlet 32 opens into a treatment region 36 in which the liquid, here water, is admixed with oxidant and in particular ozone. The treatment region 36 comprises a tank 34 in which the water can be stored. A transport means 37 leads from the tank 34 to an outlet piece 38 via which the treated water can be discharged, for example in order to be drunk by a user. Furthermore, the outlet piece 38 has a closure element 40 by means of which an opening 42 can be opened and closed to discharge the treated water as desired. The outlet piece 38 has a supply element 39 which serves to bring the treated water to the opening 42.

Furthermore, a discharge element 44, by means of which the treated liquid can be discharged from the outlet piece 38 when the opening 42 is closed, is provided in the outlet piece 38. In the example shown, the discharge element 44 is configured so that the treated liquid is recirculated to the tank 34.

The apparatus 30 further comprises a transport device 46, for example a pump, by means of which the liquid can be circulated within the apparatus 30. A unit 48 for reducing the concentration of the oxidant is likewise present and in the example shown is arranged in the region of the outlet piece 38. In the example shown, it is activated when liquid is drawn via the outlet piece 38. The unit 48 is normally switched off during circulation of the liquid.

The generator 11 or the electrolysis cell 10 is arranged in the transport means 37, but can also be installed at any desired place in the apparatus 30, for example in the tank 32 or in the outlet piece 38. The measurement device 26 for determining the conductivity, the oxidation-reduction potential or the oxidation content of the liquid is, in the example shown, not integrated into the electrolysis cell 10 but instead arranged upstream of the electrolysis cell 10 and connected via a line 50 to the electrolysis cell 10. The conductivity of the water can thus be measured at any place in the apparatus 30, for example in the transport means 37, as shown here.

When the electrolysis cell 10 is activated, the liquid which flows through the electrolysis cell 10 is provided with oxidant, preferably with ozone. After leaving the electrolysis cell 10, the oxidant, preferably ozone, is transported by the liquid within the apparatus 30. To this end, the transport device 46 conveys the liquid within the transport means 37 in the direction of the arrows, with the closure element 40 closed, so that the ozone is also conveyed to the outlet piece 38 and back into the tank 34. This ensures that both the tank 34 and also the transport means 36, and in particular the outlet piece 38, are flushed with the ozone-containing water so that the necessary number of germs are inactivated and in particular retrograde contamination of the apparatus 30 and the formation of biofilms in the apparatus 30 are prevented.

The control device 31 is configured to apply a voltage above a threshold value to the electrodes 12,14. The threshold value is dependent on the spacing A, in particular proportional to this spacing A. The control device 31 can also monitor the current between the electrodes 12,14. If it is recognised that this current is decreasing sharply, the voltage is temporarily increased to above a threshold value. Normal operation is subsequently resumed again.

The control device is also arranged to effect a regular reversal of the polarity of the electrolysis cell 10. The electrode 12, 14 that acted as cathode before the polarity reversal becomes the anode. The electrode 12, 14 that acted as anode before the polarity reversal becomes the cathode.

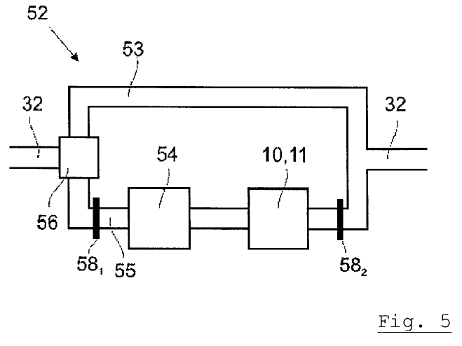

In FIG. 5, a bypass 52, which can be installed at any place in the device 26 according to the invention, is shown. In the example shown, the bypass 52 is arranged in the inlet 32 which divides into a first section 53 and a second section 55 and subsequently unites again. The electrolysis cell 10 and a treatment unit 54 are arranged in the section 55. In the example shown in FIG. 5, the treatment unit 54 is arranged upstream of the electrolysis cell 10. The liquid may be conditioned, for example softened or partially or fully demineralised or mechanically filtered, by means of the treatment unit 54. The bypass 52 further comprises an adjustment device 56 by means of which the ratio of the volume flow in the first section 53 to the volume flow in the second section 55 can be set. In this way, the oxidant and ozone concentration in the device 26 can also be selected. Furthermore, the bypass 52 allows simple replacement of the electrolysis cell 10 or the treatment unit 54. The adjustment device 56 may be configured such that all the water flows through the first section 53. The electrolysis cell 10 or the treatment unit 54 can then be replaced without having to shut down the entire device 26. Furthermore, the entire bypass 52 or the second section 55 or the electrolysis cell 10 or the treatment unit 54 may be configured as a replaceable unit, which may be separated from the adjoining components and be reconnected to them in a particularly simple way. To this end, a first clamping-off unit 58₁ and a second clamping-off unit 58₂ are provided, which on the one hand can each be closed in order to prevent passage of the liquid and on the other hand simplify the installation and removal of the second section 55 of the bypass 52 located therebetween together with the units arranged therein, here the treatment unit 54 and the electrolysis cell 10.

### LIST OF REFERENCE NUMERALS

10 Electrolysis cell
11 Generator
12 First electrode
14 Second electrode
15 Free space
17 Support core
18 Power supply
20 Particulate solid-state electrolyte
22 Ion exchanger
24 Zeolite, polymer
25 Retention device
26 Measurement device
27 Projection
28 Diamond coating
29 Ceramic material
30 Apparatus
31 Control device
32 Inlet
34 Tank
36 Treatment region
37 Transport means
38 Outlet piece
39 Supply element
40 Closure element
42 Opening
44 Discharge element
46 Transport device
48 Unit
50 Line
52 Bypass
53 First section
54 Filter
55 Second section
56 Adjustment device
58 Clamping-off unit

What is claimed is:

1. An electrolysis cell for generating oxidants, in particular ozone, for treating a liquid, comprising
a first electrode and
a second electrode,
wherein the first electrode and the second electrode are arranged at a distance (A) to one another and wherein a particulate solid-state electrolyte is arranged between the first electrode and the second electrode, through which the liquid can flow, wherein the solid-state electrolyte is arranged in a free space delimited by the first electrode and the second electrode.

2. The electrolysis cell according to claim 1, wherein the first electrode and the second electrode are provided with a support core and a diamond coating.

3. The electrolysis cell according to claim 1, wherein the first electrode has a first surface (F1) and the second electrode has a second surface (F2), which are in contact with the particulate solid-state electrolyte, and wherein the first surface and the second surface (F1, F2) are arranged in plan-parallel to one another.

4. The electrolysis cell according to claim 3, wherein the first surface and the second surface (F₁, F₂) are provided with one or more projections.

5. An apparatus for treating a liquid, comprising
an inlet for introducing liquid into the apparatus,
an outlet piece for discharging the treated liquid from the apparatus,
a treatment region which can be supplied with water for treating the water and
an electrolysis cell for generating oxidants, and in particular ozone, for treatment of the liquid according to claim 1.

6. The apparatus according to claim 5, wherein the apparatus is configured to reverse the polarity of the electrolysis cell, so that the first electrode and the second electrode alternately act as cathode and as anode.

7. The apparatus according to claim 5, further comprising a measurement device for determining at least one parameter from the group comprising conductivity, oxidation-reduction potential and ozone content of the liquid, wherein the apparatus is configured to activate the electrolysis cell in dependence on a determinable event.

8. The apparatus according to claim 7, wherein the apparatus comprises a measurement device for determining the conductivity of the liquid and wherein the apparatus is configured to set a cell voltage in dependence on the conductivity.

9. The apparatus according to claim 7, wherein a cell resistance can be determined by the measurement device, and wherein the measurement device is provided with a power supply for controlling the voltage in dependence on the measured cell resistance.

10. The apparatus according to claim 5, wherein the outlet piece comprises
a closable opening for selective discharge of the liquid,
a supply element for supplying the liquid to the outlet piece and
a discharge element for discharging the liquid from the outlet piece and for leading it into a tank.

11. The apparatus according to claim 5, further comprising a unit for reducing a concentration of the oxidant.

12. The apparatus according to claim 5, further comprising a bypass having a first section and a second section, wherein the electrolysis cell is arranged in one of the sections.

13. A method of generating ozone for the treatment of a liquid, comprising the following steps:
determining the conductivity, the oxidation-reduction potential or the ozone concentration of a liquid present in an apparatus according to claim 5 by a measurement device,
activating a generator for generating an oxidant in dependence on the determined conductivity, the oxidation-reduction potential, the ozone concentration or a determinable event by the measurement device, and
treating the liquid and liquid-conducting parts of the apparatus with the oxidant.

14. The method according to claim 13, wherein a polarity of the electrolysis cell is reversed so that the first electrode and the second electrode alternately act as cathode and anode.

15. The method according to claim 14, wherein the polarity reversal occurs at regular intervals.

16. The method according to claim 13, wherein the oxidant is ozone.

17. The electrolysis cell according to claim 2, wherein the first electrode has a first surface (F1) and the second electrode has a second surface (F2), which are in contact with the particulate solid-state electrolyte, and wherein the first surface and the second surface (F1, F2) are arranged in plan-parallel to one another, and wherein the first surface and the second surface (F₁, F₂) are provided with one or more projections.

18. The apparatus according to claim 6, further comprising a measurement device for determining at least one parameter from the group comprising conductivity, oxidation-reduction potential and ozone content of the liquid, wherein the apparatus is configured to activate the electrolysis cell in dependence on a determinable event, and wherein the apparatus comprises a measurement device for determining the conductivity of the liquid and wherein the apparatus is configured to set a cell voltage in dependence on the conductivity.

19. The apparatus according to claim 18, wherein a cell resistance can be determined by the measurement device, and wherein the measurement device is provided with a power supply for controlling the voltage in dependence on the measured cell resistance, and wherein the outlet piece comprises a closable opening for selective discharge of the liquid, a supply element for supplying the liquid to the outlet piece and a discharge element for discharging the liquid from the outlet piece and for leading it into a tank.

20. The apparatus according to claim 19, further comprising a unit for reducing a concentration of the oxidant, and further comprising a bypass having a first section and a second section, wherein the electrolysis cell is arranged in one of the sections.
